(19) United States
(12) Patent Application Publication
(10) Pub. No.: US 2026/0019180 A1
(43) Pub. Date: Jan. 15, 2026

(54) ON-DEMAND LABELLING FOR CHANNEL CLASSIFICATION TRAINING

(71) Applicant: Nokia Technologies Oy, Espoo (FI)

(72) Inventors: Chen Hui YE, Shanghai (CN); Shuang YAO, Shanghai (CN); Heng PAN, Shanghai (CN); Muhammad Ikram ASHRAF, Espoo (FI); Athul PRASAD, Naperville, IL (US); István Zsolt KOVÁCS, Aalborg (DK)

(21) Appl. No.: 18/993,941

(22) PCT Filed: Jul. 15, 2022
(86) PCT No.: PCT/CN2022/105916

§ 371 Date: Jan. 13, 2025

(51) Int. Cl. H04B 17/391; G06F 18/241; H04W 64/00

(52) U.S. Cl. CPC H04B 17/3913; G06F 18/241; H04W 64/006

(57) ABSTRACT

Example embodiments of the present disclosure relate to on-demand labelling for channel classification training. A first device determines, using a classification model, a classification result of a communication channel based at least in part on channel measurement information about the communication channel, and determines, based at least in part on a type of the classification model, importance assessment information to indicate an importance level of the channel measurement information in updating the classification model. The first device transmits the importance assessment information to a second device. In accordance with a determination that the importance level of the channel measurement information exceeds the importance threshold, the second device causes a third device to perform classification labeling for at least the communication channel at a location associated with the first device.

### FIELD

Embodiments of the present disclosure generally relate to the field of telecommunication and in particular, to methods, devices, apparatuses and computer readable storage medium for on-demand labelling for channel classification training.

### BACKGROUND

Location-awareness is a fundamental aspect of wireless communication networks and will enable a myriad of location-enabled services in different applications. The integration and utilization of location information in day-to-day applications will grow significantly as the technology's accuracy evolves.

Many positioning technologies that depend on techniques such time of arrival (TOA), time difference of arrival (TDOA) and angle of arrival (AOA) require light-of-sight (LOS) propagation between a reference point (such as a network device) and a mobile device to be positioned. However, as for non-line-of-sight (NLOS) propagation cases in indoor/outdoor environments, positioning accuracy deteriorates remarkably due to incapability in identifying reflected multipath radio frequency (RF) propagations from diverse arriving angles with diverse delay spreads. Artificial intelligence (AI) algorithms, on the other hand, is intrinsically superior in terms of accuracy and efficiency for fingerprint styled positioning inference regardless of LOS or NLOS. Therefore, classifying the channel propagation is important at least due to its impact on choosing positioning approaches.

### SUMMARY

The scope of protection sought for various embodiments of the invention is set out by the independent claims. The embodiments/examples and features, if any, described in this specification that do not fall under the scope of the independent claims are to be interpreted as examples useful for understanding various embodiments of the invention.” Please note that the term “embodiments” or “examples” should be adapted accordingly to the terminology used in the application, i.e., if the term “examples” is used, then the statement should talk of “examples” accordingly, or if the term “embodiments” is used, then the statement should talk of “embodiments” accordingly.

Embodiments that do not fall under the scope of the claims, if any, are to be interpreted as examples useful for understanding various embodiments of the disclosure.

In a first aspect, there is provided a first device. The first device comprises at least one processor; and at least one memory storing instructions that, when executed by the at least one processor, cause the first device at least to: determine, using a classification model, a classification result of a communication channel based at least in part on channel measurement information about the communication channel; determine, based at least in part on a type of the classification model, importance assessment information to indicate an importance level of the channel measurement information in updating the classification model; and transmit the importance assessment information to a second device.

In a second aspect, there is provided a second device. The second device comprises at least one processor; and at least one memory storing instructions that, when executed by the at least one processor, cause the second device at least to: receive, from a first device, importance assessment information indicating an importance level of channel measurement information in updating a classification model, the classification model being used for determining a classification result of a communication channel based on the channel measurement information; determine whether the importance level of the channel measurement information exceeds an importance threshold; and in accordance with a determination that the importance level of the channel measurement information exceeds the importance threshold, cause a third device to perform classification labeling for at least the communication channel at a location associated with the first device.

In a third aspect, there is provided a method. The method comprises: determining, at a first device and using a classification model, a classification result of a communication channel based at least in part on channel measurement information about the communication channel; determining, based at least in part on a type of the classification model, importance assessment information to indicate an importance level of the channel measurement information in updating the classification model; and transmitting the importance assessment information to a second device.

In a fourth aspect, there is provided a method. The method comprises: receiving, at a second device and from a first device, importance assessment information indicating an importance level of channel measurement information in updating a classification model, the classification model being used for determining a classification result of a communication channel based on the channel measurement information; determining whether the importance level of the channel measurement information exceeds an importance threshold; and in accordance with a determination that the importance level of the channel measurement information exceeds the importance threshold, causing a third device to perform classification labeling for at least the communication channel.

In a fifth aspect, there is provided a first apparatus. The first apparatus comprises: means for determining, using a classification model, a classification result of a communication channel based at least in part on channel measurement information about the communication channel; means for determining, based at least in part on a type of the classification model, importance assessment information to indicate an importance level of the channel measurement information in updating the classification model; and means for transmitting the importance assessment information to a second apparatus.

In a sixth aspect, there is provided a second apparatus. The second apparatus comprises: means for receiving, from a first apparatus, importance assessment information indicating an importance level of channel measurement information in updating a classification model, the classification model being used for determining a classification result of a communication channel based on the channel measurement information; means for determining whether the importance level of the channel measurement information exceeds an importance threshold; and means for, in accordance with a determination that the importance level of the channel measurement information exceeds the importance threshold, causing a third apparatus to perform classification labeling for at least the communication channel at a location associated with the first apparatus.

In a seventh aspect, there is provided a computer readable medium. The computer readable medium comprises instructions stored thereon for causing an apparatus to perform at least the method according to the first aspect.

In an eighth aspect, there is provided a computer readable medium. The computer readable medium comprises instructions stored thereon for causing an apparatus to perform at least the method according to the second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling flow for communication according to some example embodiments of the present disclosure;

FIG. 3A and FIG. 3B illustrate examples of a classification model of a first type according to some example embodiments of the present disclosure;

FIG. 4 illustrates a flowchart of a process for determining importance assessment information according to some example embodiments of the present disclosure;

FIG. 5 illustrates an example of a classification model of a second type and reference classification models generated therefrom according to some example embodiments of the present disclosure;

FIG. 6 illustrates a flowchart of a process for determining importance assessment information according to some further example embodiments of the present disclosure;

FIG. 7A and FIG. 7B illustrate model performance gain by some example embodiments of the present disclosure relative to a traditional model training approach;

FIG. 8 illustrates a flowchart of a method implemented at a first device according to some example embodiments of the present disclosure;

FIG. 9 illustrates a flowchart of a method implemented at a second device according to some example embodiments of the present disclosure;

FIG. 10 illustrates a simplified block diagram of an apparatus that is suitable for implementing example embodiments of the present disclosure; and

FIG. 11 illustrates a block diagram of an example computer readable medium in accordance with some example embodiments of the present disclosure.

Throughout the drawings, the same or similar reference numerals represent the same or similar element. Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “model” is referred to as an association between an input and an output learned from training data, and thus a corresponding output may be generated for a given input after the training. The generation of the model may be based on a machine learning (ML) technique. The machine learning techniques may also be referred to as artificial intelligence (AI) techniques. In general, a machine learning model can be built, which receives input information and makes predictions based on the input information. For example, a classification model may predict a category of input information among a predetermined number of categories. As used herein, “model” may also be referred to as “machine learning model”, “learning model”, “machine learning network”, or “learning network,” which are used interchangeably herein.

Deep learning (DL) is one of machine learning algorithms that processes the input and provides the corresponding output using a plurality of layers of processing units. A neural network (NN) model is an example of a deep learning-based model. The neural network can process an input to provide a corresponding output, and usually includes an input layer, an output layer, and one or more hidden layers between the input layer and the output layer. The neural network used in deep learning usually includes a large number of hidden layers to increase the depth of the network. The layers of the neural network are connected in order, so that the output of a preceding layer is provided as the input of a next layer, where the input layer receives the input of the neural network, and the output of the output layer is regarded as a final output of the neural network. Each layer of the neural network includes one or more nodes (also referred to as processing nodes or neurons), each of which processes input from the preceding layer.

Generally, model lifecycle management may usually include three stages, i.e., a training stage, a validation stage, and an application stage (also referred to as an inference stage). At the training stage, a given machine learning model may be trained (or optimized) iteratively using a great amount of training data until the model can obtain, from the training data, consistent inference similar to those that human intelligence can make. During the training, a set of parameter values of the model is iteratively updated until a training objective is reached. Through the training process, the machine learning model may be regarded as being capable of learning the association between the input and the output (also referred to an input-output mapping) from the training data. At the validation stage, a validation input is applied to the trained machine learning model to test whether the model can provide a correct output, so as to determine the performance of the model. Generally, the validation stage may be considered as a step in a training process, or sometimes may be omitted. At the inference stage, the resulting machine learning model may be used to process a real-world model input based on the set of parameter values obtained from the training process and to determine the corresponding model output. In some cases, a retraining or updating stage may be included in the model lifecycle management, to enable the model evolved to have better performance.

### Example Environment

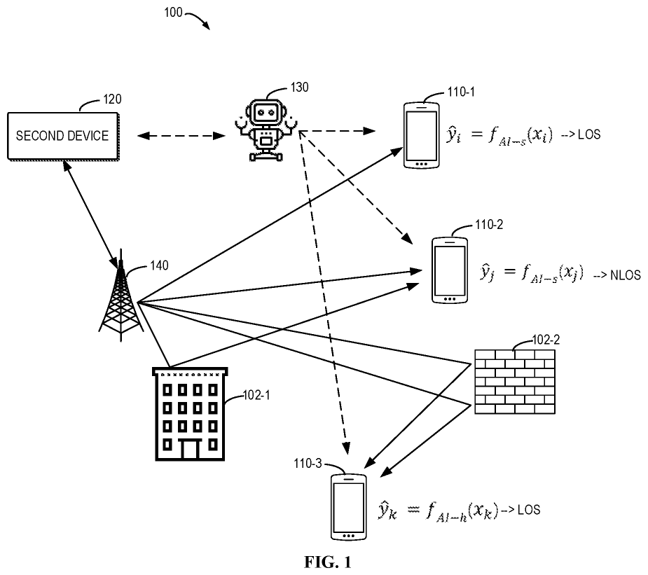

FIG. 1 illustrates an example communication environment 100 in which example embodiments of the present disclosure can be implemented. In the communication environment 100, a plurality of communication devices are involved, including one or more first devices 110-1, 110-2, and 110-3, a second device 120, a third device 130, and a fourth device 140. For the purpose of discussion, the first devices 110-1, 110-2, and 110-3 are collectively or individually referred to as first devices 110.

It is to be understood that the number of devices and their connections shown in FIG. 1 are only for the purpose of illustration without suggesting any limitation. The communication environment 100 may include any suitable number of devices adapted for implementing embodiments of the present disclosure. Although not shown, it would be appreciated that one or more additional devices may be involved in the communication environment 100.

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In the communication environment 100, the first devices 110 and the fourth device 140 can communicate with each other. In the example of FIG. 1, the first device 110 is illustrated as a terminal device while the fourth device 140 is illustrated as a network device such as a transmission-reception point (TRP). In some example embodiments, if the first device 110 is a terminal device and the fourth device 140 is a network device, a link from the fourth device 140 to the first device 110 is referred to as a downlink (DL), while a link from the first device 110 to the fourth device 140 is referred to as an uplink (UL).

Positioning techniques may be applied to obtain location information of the first devices 110. In some example embodiments, the positioning techniques may be based on DL and DL plus UL positioning measurement taken at a first device 110 for UE-assisted positioning or UL and DL plus UL measurements at the fourth device 140 for network-assisted positioning. In some cases, depending on the category of the communication channel between the first device 110 and the fourth device 140, different positioning techniques may be applied for assurance of positioning accuracy. For example, identifying whether the communication channel has light-of-sight (LOS) propagation or non-line-of-sight (NLOS) propagation, different positioning approaches may be applied. Thus, identifying a category of a communication channel is import at least for its impact on the accuracy of positioning estimation.

It has been proposed to deploy one or more classification models at a first device 110 to predict a classification result of a communication channel between the first device 110 and the fourth device 140. A classification model may be built based on AI techniques. The processing by the classification model may be represented as ŷ=f_{AI}(x), where f_{AI}( ) represents the classification model, x represents channel measurement information related to the communication channel, ŷ represents a classification result resulted predicted by the classification model, to indicate which category the communication channel is classified into.

The first devices 110 may detect a reference signal propagated from the fourth device 140 over respective communication channels, to obtain the channel measurement information. In some example embodiments, the fourth device 140 may transmit the reference signal based on the configuration or signaling from the second device 120. In some example embodiments, a communication channel may be classified by the classification model into either a LOS channel (with LOS propagation) or a NLOS channel (with NLOS propagation).

In some example embodiments, the second device 120 may maintain and manage the classification model(s) used by the first devices 110. The second device 120 may include a location server or controller. In some example embodiments, the second device 120 may include a network element in a core network (CN) which is configured for location management. In some example embodiments, the second device 120 may include a location management function (LMF) although other terminologies may be used.

The accuracy of a classification model relies on training data. A pre-requirement in model supervised learning is that the training data needs to be labelled beforehand. For a classification model configured for channel classification, the labelled training data may include sample channel measurement information as a sample model input, and a ground-truth classification result as a ground-truth model label. It typically requires external gears/devices support for in-field measurement and labelling.

For example, the third device 130 in the communication environment 100 may be configured to facilitate the in-field measurement and classification labelling. The third device 130 is usually capable of determining its location. In some example embodiments, the third device 130 may include a positioning reference unit (PRU) although other terminologies may be used. This third device 130 may be requested by the second device 120 to perform in-field measurement and determine a ground-truth classification result for channel measurement information measured at that location. It is noted that although one third device is illustrated, there may be a plurality of third devices which may be requested to perform classification labelling.

In some cases, a classification model may be evolved or finetuned to have better performance (e.g., higher accuracy) even the model has been deployed to the first devices. Such model evolving may require additional labelled training data. However, there lacks knowledge to properly decide and request a third device to perform in-field measurement and labelling. If one or more third devices are requested to perform the labelling, the collected training data may not always be useful in improving the model performance. It leads to waste resources by requiring the third device to conduct labelling on areas where the current classification model can already provide descent estimation results or miss the blind spots where more training samples are demanded for model training.

For the purpose of efficient training data update and model retraining, it is expected to a minimal quantity of decently labelled training data which are considered as informative and can help improve the model performance.

### Work Principle and Example Signaling Flow

According to some example embodiments of the present disclosure, there is provided a solution for on-demand labelling for channel classification training. In this solution, a first device determines, based on a type of a classification model, importance assessment information to represent an importance level of channel measurement information in updating of the classification model. The importance assessment information is transmitted to a second device. The second device compares the importance level with an importance threshold. If the importance level of the channel measurement information exceeds the importance threshold, the second device causes a third device to perform classification labelling for the communication channel of the first device. In this way, by assessing the importance of the channel measurement information to the improvement of the classification model, it is possible to perform on-demand labelling in a coordinated manner. The labelling overhead of the third device is reduced, and efficient labelled training data updates can be achieved for model improvement.

In some example embodiments, more training data may be obtained from the classification labelling to update or train the classification model. In this case, efficient model training becomes feasible to achieve optimal training performance with a small set of decently labelled training data.

Example embodiments of the present disclosure will be described in detail below with reference to the accompanying drawings.

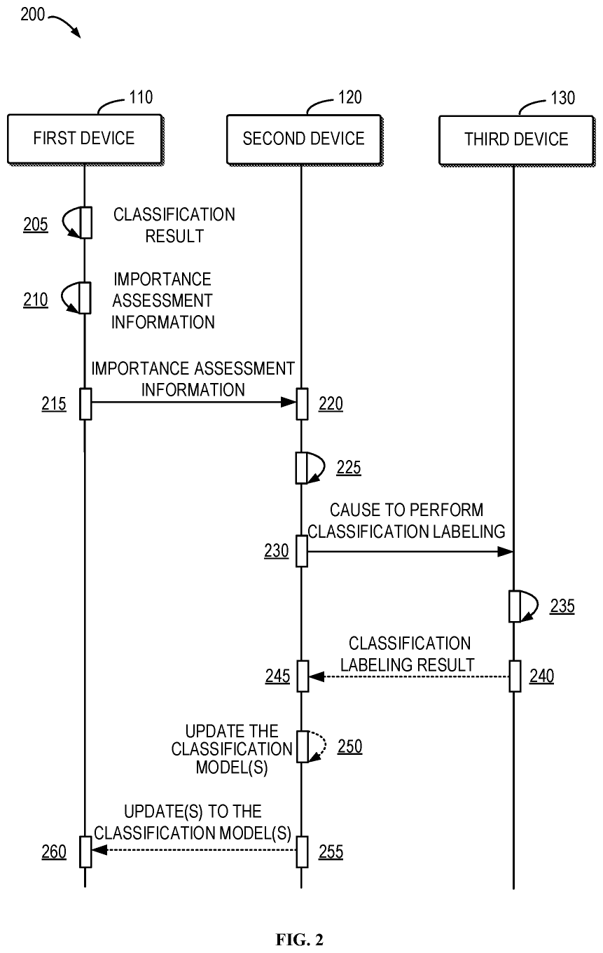

Reference is now made to FIG. 2, which shows a signaling flow 200 for communication according to some example embodiments of the present disclosure. As shown in FIG. 2, the signaling flow 200 involves a first device 110, a second device 120, and a third device 130. For the purpose of discussion, reference is made to FIG. 1 to describe the signaling flow 200. Although one first device 110 and one third device 130 are illustrated in FIG. 2, it would be appreciated that there may be a plurality of first device performing similar operations as described with respect to the first device 110 below and a plurality of third device performing similar operations as described with respect to the third device 130 below.

The first device 110 determines 205 a classification result of a communication channel based at least in part on channel measurement information about the communication channel. A classification model is applied to determine the classification result for the communication channel.

In some example embodiments, the fourth device 140 may transmit a reference signal, and the first device 110 may measure the reference signal propagated over a communication channel between the first device 110 and the fourth device 140, to obtain the channel measurement information. In some example embodiments, the first device 110 may include a terminal device, and the fourth device 140 may include a network device.

The channel measurement information may include one or more types of information that are useful in characterizing the communication channel. In some example embodiments, the channel measurement information may include a channel impulse response (CIR), channel status information (CSI), Received Signal Strength Indicator (RSSI), Reference Signal Received Power (RSRP), and/or other information that can be measured.

The classification model may be constructed to extract representative features of the channel measurement information in a high dimensional feature space via machine learning and use the features to classify the communication channel. The classification model may be configured with a plurality of potential channel categories into which a communication channel may be classified. In some example embodiments, the classification model may perform two-category classification, to classify a communication channel into either a first channel category or a second channel category. In some example embodiments, the plurality of channel categories may include a LOS channel and a NLOS channel. The classification result may indicate a predicted probability of the communication channel being classified into a LOS channel or a NLOS channel. Depending on actual applications, other channel categories may also be defined, which is not limited in the scope of the present disclosure.

In addition to classifying the communication channel, the first device 110 further determines whether and/or how to report assistance information to facilitate on-demand classification labelling. Specifically, the first device 110 determines 210, based at least in part on a type of the classification model, importance assessment information to indicate an importance level of the channel measurement information in updating the classification model. The first device 110 transmits 215 the importance assessment information to the second device 120.

It is beneficial to adopt on-demand classification labelling in training in terms of lifecycle management of at least the classification model applied by the first device 110. In example embodiments of the present disclosure, the first device 110 determines the importance assessment information related to the channel measurement information, which may enable the second device 120 to trigger the third device 130 to perform classification labelling in the case that channel measurement information is found to be important in updating the classification model. As used herein, channel measurement information important in updating the classification model may involve the case that the channel measurement information is informative and provide new features that are currently not captured by the classification model. In this case, classification labelling of the corresponding communication channel can provide new informative training data to help finetune the classification model, for example, to correctly classify communication channels with similar characteristics.

Different importance assessment information may be determined for different types of classification models. To measure whether the channel measurement information is important in updating the classification model, in some example embodiments, the importance assessment information may be determined based on uncertainty or trustworthiness of the classification result determined by the model based on the channel measurement information. In some example embodiments, an uncertainty level of the classification result may be determined, where the uncertainty level may represent the degree to which the classification model is confident on or doubt about its classification result. The uncertainty level may also be referred to as a doubtfulness level. As an alternative, in contrast to the “uncertainty level,” a certainty level, reliability level, or confidence level of the classification result may be measured.

Generally, it cannot directly identify the root cause of classification error between “ambiguity of the channel itself” and “estimation immaturity of the classification model.” However, the immaturity of the classification model has not been considered, which will likely mislead the second device 120 to take improper follow-up actions. For example, if the classification ambiguity is caused by the ambiguity of the channel itself while the classification model is believed to be confident on the classification result, it may impact on choosing follow-up positioning approaches between the geometric typed (e.g., TDOA, AOA, AOD) or fingerprint typed schemes. On the other hand, if the classification ambiguity is caused by the immaturity of the classification model before it is fully trained or finetuned, it may impact on the follow-up training data enhancement and model updating in terms of model lifecycle management, that is, more labelled training data needs to be collected for model finetuning.

For example, in FIG. 1, it is assumed that the first device 110-1 may obtain channel measurement information represented as xᵢ and use a classification model represented as f_{AI-s}( ) to generate a classification result, ŷᵢ=f_{AI-s}(xᵢ), to indicate that the communication channel is a LOS channel. The first device 110-2 may obtain channel measurement information represented as xⱼ and use a classification model represented as f_{AI-s}( ) to generate a classification result, ŷⱼ=f_{AI-s}(xⱼ), to indicate that the communication channel is a NLOS channel. The first device 110-3 may obtain channel measurement information represented as xₖ and use a different type of classification model represented as f_{AI-h}( ) to generate a classification result, ŷₖ=f_{AI-h}(xₖ), to indicate that the communication channel is a LOS channel. By considering the actual propagation conditions of the communication channels, it can be determined that the classification result at the first device 110-1 is trustworthy, while the classification results at the first devices 110-2 and 110-3 are doubtful.

In view of the above, it is beneficial to assess the uncertainty or trustworthiness of the classification result given by the current classification model. In some example embodiments, the important level of the channel measurement information may be determined based on the uncertainty level of the classification result. The importance assessment information may be generated to at least include the uncertainty level of the classification result. In some example embodiments, a higher uncertainty level of the classification result may correspond to a higher important level of the channel measurement information, which means that the communication channel or the channel measurement information may be important so that the classification labelling is needed.

In some example embodiments, the uncertainty level for different types of classification models may be determined in different approaches, by considering the classifying schemes implemented by the classification models. Some types of classification model may require relatively high overhead for calculating the uncertainty level, while some other types of classification model may require relatively low overhead.

For some types of classification model (for example, a first type of classification model) which require high overhead for calculating the uncertainty level, the first device 110 may determine the uncertainty level of the classification and generate the importance assessment information to at least comprise the uncertainty level. In some example embodiments, an uncertainty level of a classification result output from the first type of may be determined based on intermediate output information obtainable from the model, and thus reconstructing the classification model is not needed. In such cases, the calculation of the uncertainty level may not introduce high overhead and thus may be implemented at the first device 110.

For some other types of classification model (for example, a second type of classification model) which require low overhead, the first device 110 may request other device, such as the second device 120, to assist in determining the certainty level. In some example embodiments, an uncertainty level of a classification result output from the second type of classification model may be determined by reconstructing the classification model which may causes high overhead and resource consumption. In those embodiments, the first device 110 may provide at least the channel measurement information to the second device 120. As such, the important assessment information may comprise at least the channel measurement information. The first device 110 may transmit, to the second device 120, an assistance request comprising the important assessment information. Upon receipt of the assistance request, the second device 120 may determine the uncertainty level based on the channel measurement information.

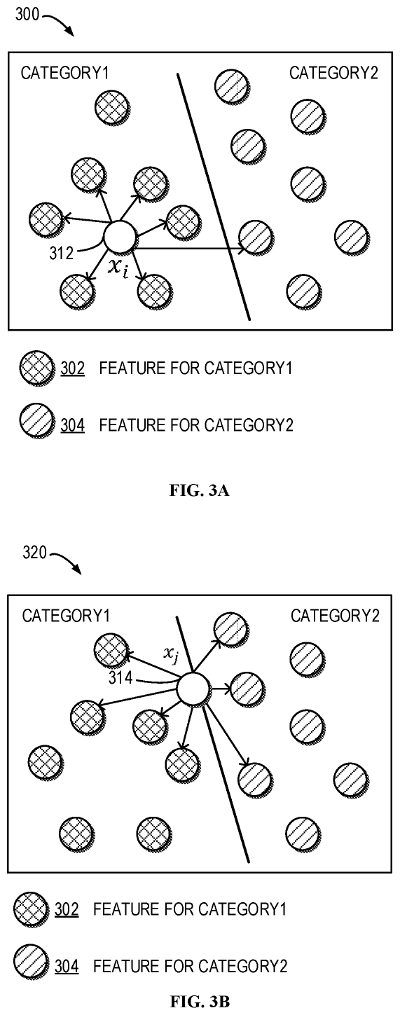

Some example embodiments of calculating the uncertainty level for different types of classification model will be described in detail below with reference to FIG. 3 to FIG. 6.

In some example embodiments, in addition to the factor of the uncertainty level of the classification result or as an alternative, the importance level of the channel measurement information may be determined based on other factors which can indicate whether the current communication channel of the first device 110 is informative or important to the improvement of the classification model.

It has been described above from the perspective of the first device 110 that importance assessment information related to channel measurement information about a certain communication channel is reported to the second device. In some example embodiments, the fourth device 140 may obtain the channel measurement information, e.g., by receiving it from the first device 110 or by measuring a reference signal transmitted from the first device 110. In such cases, if the classification model is deployed at the fourth device 140, the fourth device 140 may perform similar operations as described herein with respect to the first device 110. In other words, a network device may also transmit the importance assessment information to facilitate the classification labelling for updating the classification model.

At the side of the second device 120, it receives 220 the importance assessment information and thus can determine the importance level of the channel measurement information obtained at the first device 110. The second device 120 determines 225 whether the importance level of the channel measurement information exceeds an importance threshold. The importance threshold may be any predetermined threshold level.

In some example embodiments, if the importance assessment information from the first device 110 includes the uncertainty level of the classification result, the second device 120 may determine an importance level of the corresponding channel measurement information based on the uncertainty level and compare the importance level with the importance threshold. For example, a higher uncertainty level may correspond to a higher importance level of the corresponding channel measurement information. In some examples, the uncertainty level may be considered as an importance level of the corresponding channel measurement information. In some examples, the importance level of the corresponding channel measurement information may be determined based on one or more other factors other than the uncertainty level. In some example embodiments, if the importance assessment information from the first device 110 includes the channel measurement information itself, as mentioned above, the second device 120 may first determine the uncertainty level based on the channel measurement information. The determination of the uncertainty level will be described in detail below.

In the case that the importance level of the channel measurement information exceeds the importance threshold, the second device 120 causes 230 a third device 130 to perform classification labelling for at least the communication channel at a location associated with the first device 110. With the importance assessment information reported from the first device 110, the second device 120 can be able to assess the importance of certain channel measurement information in improvement of the classification model. The third device 130 may be requested by the second device 120 to perform the classification labelling within an area where the important channel measurement information is found.

In some cases, if the importance level of the channel measurement information is determined to be below the importance threshold, the second device 120 may discard the importance assessment information. In this way, the classification labelling is not triggered for channel measurement information that is not important in updating the model. The labelling efficiency and model updating efficiency are both improved.

The third device 130 performs 235 the classification labelling in response to the request from the second device 120. The location where the third device 130 performing the classification labelling may be any location in an area where the first device 110 is located. In some example embodiments, the second device 120 may select an appropriate third device 130 which is located in proximity of the first device 110, to conduct the classification labelling. In some example embodiments, the third device 130 may be movable and can be requested by the second device 120 to move to an area where the first device 110 is located. The third device 130 has the capability of determining a ground-truth classification result of a communication channel with the fourth device 140 in the area. The ground-truth classification result may label the communication channel as either the first channel category (e.g., the LOS channel) or the second channel category (e.g., the NLOS channel).

In some example embodiments, the third device 130 may perform further measurement on the communication channel between the first device 110 and the fourth device 140 and label the communication channel with a ground-truth classification result. For example, the third device 130 may obtain sample channel measurement information (represented as “x”) about the communication channel and determine a ground-truth classification result (represented as “y”) for the sample channel measurement information. The third device 130 may transmit 240, to the second device 120, the classification labelling result which includes a pair of the sample channel measurement information and the corresponding ground-truth classification result, {x, y}.

In some example embodiments, within the area to which the third device 130 is moved, the third device 130 may perform classification labelling for other communication channels. The third device 130 may obtain one or more additional pairs of sample channel measurement information and corresponding ground-truth classification results by changing its locations within the geographical area where the first device 110 is located and/or its antenna orientations. The classification labelling result transmitted to the second device 120 may include more than one pair of sample channel measurement information and corresponding ground-truth classification result.

The second device 120 receives 245 the classification labelling result from the third device 130 and updates 250 at least the classification model used by the first device 110 based on the classification labelling result. In some example embodiments, the second device 120 may update a training dataset with the at least one pair of sample channel measurement information and corresponding ground-truth classification result. The second device 120 may trigger the update of the classification model after enough training data are collected from the third device 130 and other data sources. For example, the second device 120 may determine whether the size of training data newly collected exceeds a threshold size. If the size exceeds the threshold size, the update of the classification model may be triggered. Since the training data are assessed as important and informative, the updated classification model may be improved to have higher accuracy.

In some cases, in addition to the classification model used in the first device 110 which reports the importance assessment information, the second device 120 may maintain one or more other classification models. The sample channel measurement information and corresponding ground-truth classification result(s) collected by the third device 130 may be shared among the classification models. In other words, the second device 120 may update the one or more other classification models based on the sample channel measurement information and corresponding ground-truth classification result(s). Those classification models maintained by the second device 120 may be of different types and/or different model configurations, but may all be configured to classify a communication channel. The channel measurement information considered as important in updating one classification model may also be important and useful in updating other classification models.

In some example embodiments, if the inputs to the different classification models are not the same (for example, different channel measurement information input are required), the third device 130 may be requested by the second device 120 to collected different sample channel measurement information about a same communication channel together with the ground-truth classification result.

The second device 120 may apply any proper updating techniques for the classification models, which are not limited in the scope of the present disclosure.

In some example embodiments, with one or more classification models updated, the second device 120 may transmit 255 an update(s) to the classification model(s) to the first device 110. The first device 110 receives 260 the update(s) to the classification model(s) and may apply the updated classification model(s) for following channel classification. In an example embodiment, the second device 120 may provide the updated classification model used by the first device 110 previously. In an example embodiment, other updated classification models may also be provided to the first device 110. The first device 110 configured with a plurality of (updated) classification model may select one of the models for use depending on, for example, the environment related to the communication channel.

### First Type of Classification Model and Uncertainty Level Calculation

As mentioned above, the importance assessment information or the uncertainty level of the channel measurement information may be determined depending on the type of the classification model.

In some example embodiments, for the first type of classification model, the uncertainty level of the classification result output from the model may be determined based on intermediate output information obtainable from the model. As an example, in the case of binary classification, a classification model may determine, based on the input channel measurement information, a first number (represented as “N1”) of model votes for a first channel category and a second number (represented as “N2”) of model votes for a second channel category.

The classification result may be determined based on a ratio of the first number to the second number (e.g., N1/N2), where a higher ratio may indicate a higher probability that the communication channel is classified into the first channel category.

For this type of classification model, the classification result is a “soft” indicator about the channel category into which the communication channel is classified. The classification model of this type may be represented as f_{AI-s}( ). It is illustrated in the example of FIG. 1 that the first devices 110-1 and 110-2 uses this type of classification model to perform the channel classification. Some examples for this type of classification model may include, but are not limited to, a k-nearest neighbor (KNN) model and a support vector machine (SVM) model.

FIG. 3A and FIG. 3B illustrate examples of a classification model of the first type according to some example embodiments of the present disclosure. FIGS. 3A and 3B illustrate a feature space 300 which includes a plurality of features 302 associated with the first channel category (represented as “Category 1”) and a plurality of features 304 associated with the second channel category (represented as “Category2”). The classifying scheme applied by the classification model is configured to measure respective distances between a feature extracted from the channel measurement information and the features in the feature space 300 and select a predetermined number (for example, K) of features with low distances (for example, K features with the lowest distances).

Among a total of K selected features, the classification model may count a first number of features associated with the first channel category (i.e., the first number of model votes for the first channel category, N1) and a second number of features associated with the second channel category (i.e., the second number of model votes for the second channel category, N2). A ratio of the first number to the second number may be used to determine the probability of the communication channel belonging to the first channel category.

In the example of FIG. 3A, a feature 312 of the channel measurement information xᵢ obtained by the first device 110-1 is close to six features associated with Category1 and one feature associated with Category2, which means that the probability of the communication channel of the first device 110-1 is 6/7. In the example of FIG. 3B, a feature 314 of the channel measurement information xⱼ obtained by the first device 110-2 is close to four features associated with Category1 and three features associated with Category2, which means that the probability of the communication channel of the first device 110-1 belonging to the first channel category is 4/7.

It would be appreciated that the examples of FIG. 3A and FIG. 3B is provided for the purpose of illustration, without suggesting the classifying approaches of the classification model of the first type. Some classification models may operate in other ways to determine the model votes for the two channel categories and then output the classification result.

In some example embodiments, the uncertainty level of the classification result output by this type of classification model may be determined based on the intermediate output information, e.g., the first number of model votes for the first channel category, N1 and the second number of model votes for the second channel category, N2.

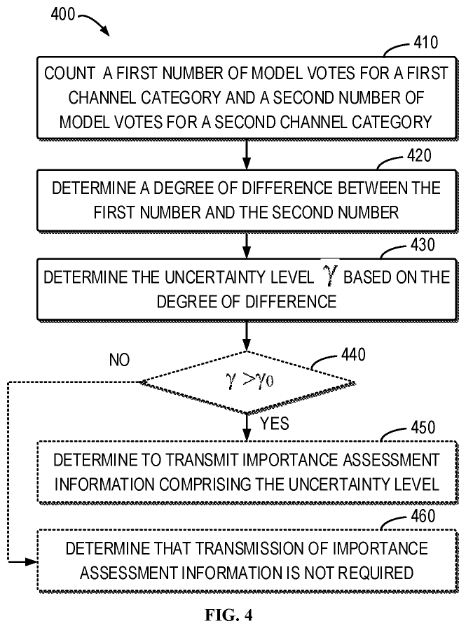

FIG. 4 illustrates a flowchart of a process 400 for determining importance assessment information according to some example embodiments of the present disclosure. The process 400 may be implemented, for example, by the first device 110.

At block 410, the first device 110 counts the first number of model votes for the first channel category, N1 and the second number of model votes for the second channel category, N2. The two numbers may be obtained from the classification model.

At block 420, the first device 110 determines a degree of difference between the first number N1 and the second number N2, and at block 430, the first device 110 determines the uncertainty level based on the degree of difference.

In the case of model votes for binary classification, if the classification model is more confident about its estimation, the number of model votes for one channel category may be larger and correspondingly, the number of model votes for the other channel category may be smaller. Therefore, if the degree of difference between the first number and the second number is high, it means that the classification model is confident on its classification result and thus the uncertainty level of the classification result may be low.

In some example embodiments, the degree of difference between the first number N1 and the second number N2 may be measured based on a lager value between N1/N2, or N2/N1, which may be represented as max(N1/N2, N2/N1). In some example embodiments, a total of N1 and N2 is determined as K, and the degree of difference between the first number N1 and the second number N2 may be measured based on a larger value between a ratio of N1 to K, and a ratio of N2 to K, which may be represented as max(N1, N2)/K. In these cases, the uncertainty level (represented as “γ”) of the classification result may be determined to be a higher level if max(N1/N2, N2/N1) or max(N1, N2)/K is determined to have a higher value. In some examples, the uncertainty level γ may be determined as follows: γ=max(N1/N2, N2/N1) or max(N1, N2)/K. In other examples, the uncertainty level γ may be determined in other ways based on the degree of difference between N1 and N2.

In some example embodiments, with the uncertainty level of the classification result determined, the first device 110 may generate the importance assessment information to at least include the determined uncertainty level.

In some example embodiments, the first device 110 may transmit the importance assessment information in the case that a relatively high uncertainty level is found. As illustrated in FIG. 4, at block 440, the first device 110 may determine whether the uncertainty level γ exceeds an uncertainty threshold, represented as γ₀. In the case that the uncertainty level γ exceeds the uncertainty threshold γ₀, at block 450, the first device 110 determines to transmit important assessment information comprising the uncertainty level to the second device 120. In the case that the uncertainty level γ does not exceed the uncertainty threshold γ₀, at block 460, the first device 110 determines that transmission of the importance assessment information is not required.

As mentioned above, a high uncertainty level may correspond to a high important level of the channel measurement information in updating the classification model. By reporting the uncertainty level exceeding the uncertainty threshold to the second device 120, it is possible to further reduce transmission overhead between the first device 110 and the second device 120.

In some example embodiments, if applicable, the first device 110 may determine the importance level of the channel measurement information based on the uncertainty level and possible some other factors, in order to generate the importance assessment information. The first device 110 may determine whether the importance level exceeds an importance threshold and decide to transmit the importance assessment information in the case that the importance level exceeds the corresponding importance threshold. The importance threshold may be the one applied at the second device 120.

In some example embodiments, the uncertainty threshold or the importance threshold may be configured by the second device 120, to control how stringent the channel measurement information is evaluated as ‘important’ or how ‘uncertain’ the classification model is about its classification result. In some example embodiments, the uncertainty threshold or importance threshold may be determined based on an accuracy level of the classification model.

For example, if the classification model has a low accuracy level at initial stage, e.g., 55%, it generally means that the model may hardly distinguish between the channel categories. The uncertainty threshold or the importance threshold may be set to a relatively low value, so that more channel measurement information may be assessed as important to allow the third device 130 to collect more training data for model updating.

In some example embodiments, the uncertainty threshold γ₀ may be updated based on an update to the classification model. As the classification model is updated and become more mature, its accuracy level may increase, and the uncertainty threshold or importance threshold may also be set to a larger value. For example, if the accuracy level of the classification model has climbed to 80%, the classification model may be more confident on its classification result and the uncertainty threshold or importance threshold may also be increased.

It would be appreciated that in some other example embodiments, instead of calculating the uncertainty level for the classification model of the first type, the first device 110 may alternatively generate and transmit the importance assessment information including the channel measurement information to the second device 120, to request the second device 120 to perform the calculation. In those embodiments, the operations at blocks 410, 420, and 430 in the process 400 may be implemented at the second device 120.

### Second Type of Classification Model and Uncertainty Level Calculation

In some example embodiments, the classification model of the second type is a type of model with an uncertainty level of a classification result to be determined by reconstructing the classification model. An example of such classification model is a deep neural network (DNN) model, which generally provides a hard output (e.g., 0 or 1) to indicate whether the communication channel is classified into the first channel category or the second channel category.

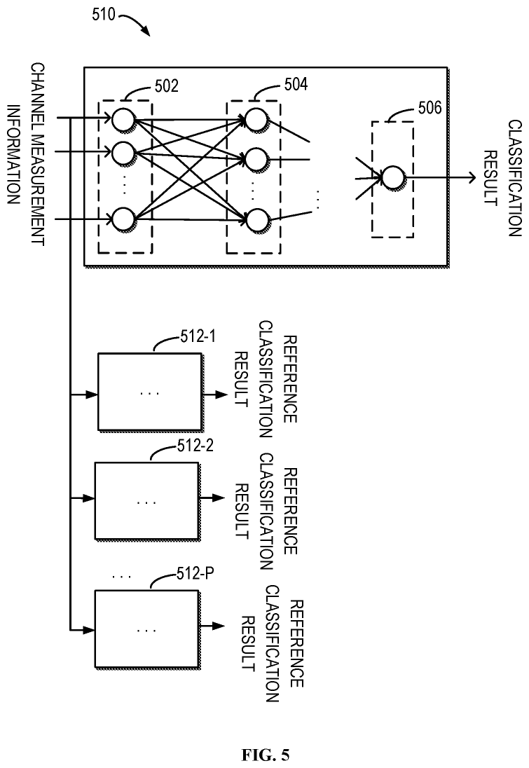

FIG. 5 illustrates an example of a classification model 510 of the second type and reference classification models generated therefrom according to some example embodiments of the present disclosure. The classification model 510 may be in form of DNN model.

As shown in FIG. 5, the classification model 510 is configured of an input layer 502, one or more intermediate layer 504, and an output layer 506, each of the layers comprising a plurality of operation units (sometimes referred to as neurons). The operation units in one layer are connected to the operation units in a following layer. In some example embodiments, the operation units in one layer may be connected with one or more other operation units in the same layer. Channel measurement information is inputted to the input layer 502 for processing, and the information is propagated through the inside of the intermediate layer(s) 504 according to the connections of the layers. A classification result for the channel measurement information is outputted from the output layer 506. Examples of the layers included in the model may include a convolution layer, the batch normalization, activation function, pooling layer, fully connected layer, LSTM (Long Short Term Memory) layer, and other types of layers.

Note that the number of operation units and the number of layers in the classification model 510 have no relation with the example embodiments of the present disclosure, and these numbers are given values. The structure of the model is also non-limiting, and may have recurrence or the bidirectional property to the connection between the operation units. Any model applicable for channel classification may be used.

For DNN typed models and similar models, there is no general solution available yet to directly measure the uncertainty level of the predicted result based on the model output or immediate information. It's noteworthy that in classification models, even if the model outputs a probability vector, which may not be directly used to indicate the uncertainty level of the classification result. That is, a classification model can be uncertain in its predictions even with a high output probability. In some example embodiments, it is proposed to reconstruct the classification model by slightly changing the model to generate a plurality of reference classification models, and determine the uncertainty level based on the plurality of reference classification models.

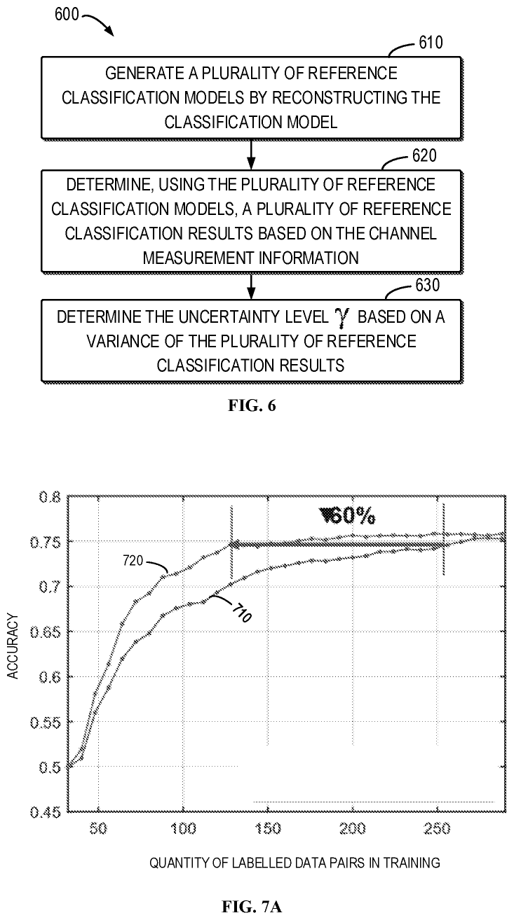

FIG. 6 illustrates a flowchart of a process 600 for determining importance assessment information according to some further example embodiments of the present disclosure. The process 600 may be implemented, for example, by the second device 120. In those embodiments, the second device 120 receive importance assessment information comprising the channel measurement information from the first device 110. To measure the importance of the channel measurement information, the second device 120 may determine an uncertainty level of the classification result output by the classification model for the channel measurement information.

At block 610, the second device 120 generates a plurality of reference classification models by reconstructing the classification model. In some example embodiments, the second device 120 may slightly change the classification model by applying random neural connection dropout on the classification model. Specifically, the second device 120 may randomly drop out some neural connections between the operation units in the classification model, to obtain a reference classification model. In some example embodiments, the second device 120 may apply a Gaussian process to determine which neural connections are dropped from the classification model. The second device 120 may generate a plurality of different reference classification models through the dropout means. The second device 120 may apply other dropout means to generate the reference classification models.

In the example of FIG. 5, the second device 120 may generate P reference classification models 512-1, 512-2, . . . , 512-P (collectively or individually referred to as reference classification models 512), where P is an integer larger than one. A reference classification model 512 may be represented as f_{AI-p}(⋅).

At block 620, the second device 120 determines, using the plurality of reference classification models, a plurality of reference classification results based on the channel measurement information. The second device 120 may apply the channel measurement information provided by the first device 110 as input to the respective reference classification model f_{AI-p}(⋅) with p=1, 2, . . . , P. The second device 120 may obtain the reference classification results output by the reference classification model, represented as ŷₚ with p=1, 2, . . . , P.

At block 630, the second device 120 determines the uncertainty level of the classification result based on a variance of the plurality of reference classification results. If the variance of the plurality of reference classification results is relatively high, which means that the reference classification models are not consistent in classifying the channel measurement information. In this case, the uncertainty level of the classification result may be determined as a relatively high level and the channel measurement information may be determined as informative and important in updating the original classification model.

In this way, the classification model can be updated to be stable and have more confidence in classifying similar communication channels even if the model structure is slightly changed (e.g., by dropping out some connections).

In some example embodiments, the uncertainty threshold or importance threshold applied for the classification models of the second type may be set in a similar way to the way applied for the classification models of the first type described above. In some example embodiments, the uncertainty threshold or importance threshold applied for the classification models of the first type and the second types may be configured as the same or different threshold.

It would be appreciated that in some other example embodiments, instead of requesting the second device 120 to calculate the uncertainty level for the classification model of the second type, the first device 110 may alternatively determine the uncertainty level locally by performing the similar operations in the process 600, and then generate and transmit the importance assessment information including the uncertainty level to the second device 120.

### Comparison of Performance Gain

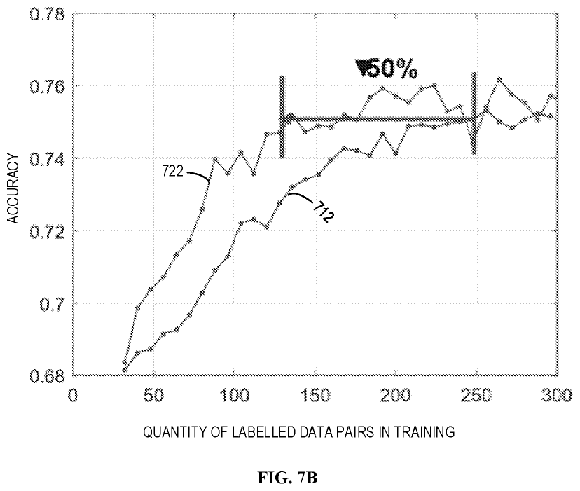

FIG. 7A and FIG. 7B illustrate model performance gain by some example embodiments of the present disclosure relative to a traditional model training approach. According to the traditional model training approach, the third device may be randomly requested by the second device to perform in-field measurement and classification labelling without assistance information. According to the example embodiments of the present disclosure, through the coordination with the first device, the second device may trigger the classification labelling in the case that important and informative channel measurement information is found.

FIG. 7A shows an accuracy trend curve 710 for the traditional model training approach and an accuracy trend curve 720 for the proposed approach according to some example embodiments of the present disclosure. The two trend curves show the accuracy climbing versus the quantity of labelled training data for training a classification model of the first type. To reach a close to a satisfying accuracy level about 0.75, the quantity of labelled training data required for the classification model to the satisfying accuracy level can be roughly reduced by 60% using the approach proposed, comparing to the traditional approach.

FIG. 7B shows an accuracy trend curve 712 for the traditional model training approach and an accuracy trend curve 722 for the proposed approach according to some example embodiments of the present disclosure. The two trend curves show the accuracy climbing versus the quantity of labelled training data for training a classification model of the first type. As shown, to achieve similar performance in terms of classification accuracy, the quantity of labelled training data required for the classification model can be roughly reduced by 50% using the proposed approach according to some example embodiments of the present disclosure, comparing to the traditional approach.

### Example Methods

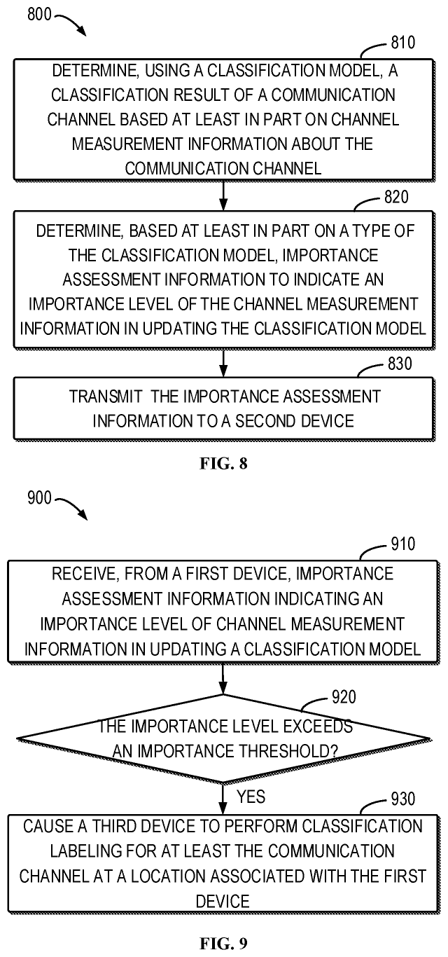

FIG. 8 shows a flowchart of an example method 800 implemented at a first device in accordance with some example embodiments of the present disclosure. For the purpose of discussion, the method 800 will be described from the perspective of the first device 110 in FIG. 1.

At block 810, the first device 110 determines, using a classification model, a classification result of a communication channel based at least in part on channel measurement information about the communication channel.

At block 820, the first device 110 determines, based at least in part on a type of the classification model, importance assessment information to indicate an importance level of the channel measurement information in updating the classification model.

At block 830, the first device 110 transmits the importance assessment information to a second device 120.

In some example embodiments, determining the importance assessment information comprises: determining whether the type of the classification model is a first type or a second type; in accordance with a determination that the type of the classification model is the first type, determining an uncertainty level of the classification result, and generating the importance assessment information to comprise at least the uncertainty level of the classification result; and in accordance with a determination that the type of the classification model is the second type, generating the importance assessment information to comprise at least the channel measurement information.

In some example embodiments, the classification model of the first type is a type of model with an uncertainty level of a classification result to be determined without reconstructing the classification model. In some example embodiments, the classification model of the second type is a type of model with an uncertainty level of a classification result to be determined by reconstructing the classification model.

In some example embodiments, the classification result indicates whether the communication channel is classified into a first channel category or a second channel category, and the classification result determined using the classification model of the first type is based on a ratio of a first number of model votes for the first channel category to a second number of model votes for the second channel category. In some example embodiments, determining the uncertainty level comprises: determining a degree of difference between the first number and the second number, and determining the uncertainty level based on the degree of difference.

In some example embodiments, transmitting the importance assessment information to the second device comprises: in accordance with a determination that the determined uncertainty level exceeds an uncertainty threshold, transmitting, to the second device, the importance assessment information.

In some example embodiments, the method 800 further comprises: receiving the uncertainty threshold from the second device.

In some example embodiments, the classification result is determined based on a predictive probability provided by the classification model of the second type, to indicate whether the communication channel is classified into a first channel category or a second channel category.

In some example embodiments, the method 800 further comprises: receiving, from the second device, an update to at least the classification model.

In some example embodiments, the classification result indicates whether the communication channel is classified into a line-of-sight channel or a non-line-of-sight channel.

In some example embodiments, the first device comprises a terminal device, and the second device comprises a location management function. In some example embodiments, the communication channel comprises a channel between the terminal device and a network device.

FIG. 9 shows a flowchart of an example method 900 implemented at a second device in accordance with some example embodiments of the present disclosure. For the purpose of discussion, the method 900 will be described from the perspective of the second device 120 in FIG. 1.

At block 910, the second device 120 receives, from a first device, importance assessment information indicating an importance level of channel measurement information in updating a classification model, the classification model being used for determining a classification result of a communication channel based on the channel measurement information.

At block 920, the second device 120 determines whether the importance level of the channel measurement information exceeds an importance threshold.

If the importance level of the channel measurement information exceeds the importance threshold, at block 930, the second device 120 causes a third device to perform classification labeling for at least the communication channel at a location associated with the first device.

In some example embodiments, the method 900 further comprises: receiving, from the third device, at least one pair of sample channel measurement information about the communication channel and a ground-truth classification result labeled for the sample channel measurement information; and updating at least the classification model based on the at least one pair of sample channel measurement information and the ground-truth classification result.

In some example embodiments, the method 900 further comprises: transmitting, to the first device, an update to at least the classification model.

In some example embodiments, receiving the importance assessment information comprises: in accordance with a determination that the classification model is of a first type, receiving the importance assessment information comprising at least an uncertainty level of the classification result; and in accordance with a determination that the classification model is of a second type, receiving the importance assessment information comprising at least the channel measurement information.

In some example embodiments, the classification model of the first type is a type of model with an uncertainty level of a classification result to be determined without reconstructing the classification model. In some example embodiments, the classification model of the second type is a type of model with an uncertainty level of a classification result to be determined by reconstructing the classification model.

In some example embodiments, the method 900 further comprises: in accordance with a determination that the importance assessment information comprises at least the channel measurement information, determining an uncertainty level of the classification result based on the channel measurement information.

In some example embodiments, the classification model is of a second type. In some example embodiments, determining the uncertainty level of the classification result comprises: generating a plurality of reference classification models by reconstructing the classification model; determining, using the plurality of reference classification models, a plurality of reference classification results based on the channel measurement information; and determining the uncertainty level of the classification result based on a variance of the plurality of reference classification results.

In some example embodiments, the plurality of reference classification models is generated by applying random neural connection dropout on the classification model.

In some example embodiments, the uncertainty level of the classification result exceeding an uncertainty threshold is received from the first device.

In some example embodiments, the method 900 further comprises: transmitting the uncertainty threshold to the first device.

In some example embodiments, the uncertainty threshold is determined based on an accuracy level of the classification model. In some example embodiments, the uncertainty threshold is updated based on an update to the classification model.

In some example embodiments, the classification result indicates whether the communication channel is classified into a line-of-sight channel or a non-line-of-sight channel.

In some example embodiments, the first device comprises a terminal device, the second device comprises a location management function, and the third device comprises a positioning reference unit. In some example embodiments, the communication channel comprises a channel between the terminal device and a network device.

### Example Apparatus, Device and Medium

In some example embodiments, a first apparatus capable of performing any of the method 800 (for example, the first device 110 in FIG. 1) may comprise means for performing the respective operations of the method 800. The means may be implemented in any suitable form. For example, the means may be implemented in a circuitry or software module. The first apparatus may be implemented as or included in the first device 110 in FIG. 1.

In some example embodiments, the first apparatus comprises means for determining, using a classification model, a classification result of a communication channel based at least in part on channel measurement information about the communication channel; means for determining, based at least in part on a type of the classification model, importance assessment information to indicate an importance level of the channel measurement information in updating the classification model; and means for transmitting the importance assessment information to a second apparatus.

In some example embodiments, the means for determining the importance assessment information comprises: means for determining whether the type of the classification model is a first type or a second type; in accordance with a determination that the type of the classification model is the first type, means for determining an uncertainty level of the classification result, and means for generating the importance assessment information to comprise at least the uncertainty level of the classification result; and means for, in accordance with a determination that the type of the classification model is the second type, generating the importance assessment information to comprise at least the channel measurement information.

In some example embodiments, the classification model of the first type is a type of model with an uncertainty level of a classification result to be determined without reconstructing the classification model. In some example embodiments, the classification model of the second type is a type of model with an uncertainty level of a classification result to be determined by reconstructing the classification model.

In some example embodiments, the classification result indicates whether the communication channel is classified into a first channel category or a second channel category, and the classification result determined using the classification model of the first type is based on a ratio of a first number of model votes for the first channel category to a second number of model votes for the second channel category. In some example embodiments, the means for determining the uncertainty level comprises: means for determining a degree of difference between the first number and the second number, and means for determining the uncertainty level based on the degree of difference.

In some example embodiments, the means for transmitting the importance assessment information to the second apparatus comprises: means for, in accordance with a determination that the determined uncertainty level exceeds an uncertainty threshold, transmitting, to the second apparatus, the importance assessment information.

In some example embodiments, the first apparatus further comprises: means for receiving the uncertainty threshold from the second apparatus.

In some example embodiments, the classification result is determined based on a predictive probability provided by the classification model of the second type, to indicate whether the communication channel is classified into a first channel category or a second channel category.

In some example embodiments, the first apparatus further comprises: means for receiving, from the second apparatus, an update to at least the classification model.

In some example embodiments, the classification result indicates whether the communication channel is classified into a line-of-sight channel or a non-line-of-sight channel.

In some example embodiments, the first apparatus comprises a terminal apparatus, and the second apparatus comprises a location management function. In some example embodiments, the communication channel comprises a channel between the terminal apparatus and a network apparatus.

In some example embodiments, the first apparatus further comprises means for performing other operations in some example embodiments of the method 800 or the first device 110. In some example embodiments, the means comprises at least one processor; and at least one memory storing instructions that, when executed by the at least one processor, cause the performance of the first apparatus.

In some example embodiments, a second apparatus capable of performing any of the method 900 (for example, the second device 120 in FIG. 1) may comprise means for performing the respective operations of the method 900. The means may be implemented in any suitable form. For example, the means may be implemented in a circuitry or software module. The second apparatus may be implemented as or included in the second device 120 in FIG. 1.

In some example embodiments, the second apparatus comprises means for receiving, from a first apparatus, importance assessment information indicating an importance level of channel measurement information in updating a classification model, the classification model being used for determining a classification result of a communication channel based on the channel measurement information; means for determining whether the importance level of the channel measurement information exceeds an importance threshold; and means for, in accordance with a determination that the importance level of the channel measurement information exceeds the importance threshold, causing a third apparatus to perform classification labeling for at least the communication channel at a location associated with the first device.

In some example embodiments, the second apparatus further comprises: means for receiving, from the third apparatus, at least one pair of sample channel measurement information about the communication channel and a ground-truth classification result labeled for the sample channel measurement information; and means for updating at least the classification model based on the at least one pair of sample channel measurement information and the ground-truth classification result.

In some example embodiments, the second apparatus further comprises: means for transmitting, to the first apparatus, an update to at least the classification model.

In some example embodiments, the means for receiving the importance assessment information comprises: means for, in accordance with a determination that the classification model is of a first type, receiving the importance assessment information comprising at least an uncertainty level of the classification result; and means for, in accordance with a determination that the classification model is of a second type, receiving the importance assessment information comprising at least the channel measurement information.

In some example embodiments, the classification model of the first type is a type of model with an uncertainty level of a classification result to be determined without reconstructing the classification model. In some example embodiments, the classification model of the second type is a type of model with an uncertainty level of a classification result to be determined by reconstructing the classification model.

In some example embodiments, the second apparatus further comprises: means for, in accordance with a determination that the importance assessment information comprises at least the channel measurement information, determining an uncertainty level of the classification result based on the channel measurement information.

In some example embodiments, the classification model is of a second type. In some example embodiments, the means for determining the uncertainty level of the classification result comprises: means for generating a plurality of reference classification models by reconstructing the classification model; means for determining, using the plurality of reference classification models, a plurality of reference classification results based on the channel measurement information; and means for determining the uncertainty level of the classification result based on a variance of the plurality of reference classification results.

In some example embodiments, the plurality of reference classification models is generated by applying random neural connection dropout on the classification model.

In some example embodiments, the uncertainty level of the classification result exceeding an uncertainty threshold is received from the first apparatus.

In some example embodiments, the second apparatus further comprises: means for transmitting the uncertainty threshold to the first apparatus.

In some example embodiments, the uncertainty threshold is determined based on an accuracy level of the classification model. In some example embodiments, the uncertainty threshold is updated based on an update to the classification model.

In some example embodiments, the classification result indicates whether the communication channel is classified into a line-of-sight channel or a non-line-of-sight channel.

In some example embodiments, the first apparatus comprises a terminal apparatus, the second apparatus comprises a location management function, and the third apparatus comprises a positioning reference unit. In some example embodiments, the communication channel comprises a channel between the terminal apparatus and a network apparatus.

In some example embodiments, the second apparatus further comprises means for performing other operations in some example embodiments of the method 900 or the second device 120. In some example embodiments, the means comprises at least one processor; and at least one memory storing instructions that, when executed by the at least one processor, cause the performance of the second apparatus.

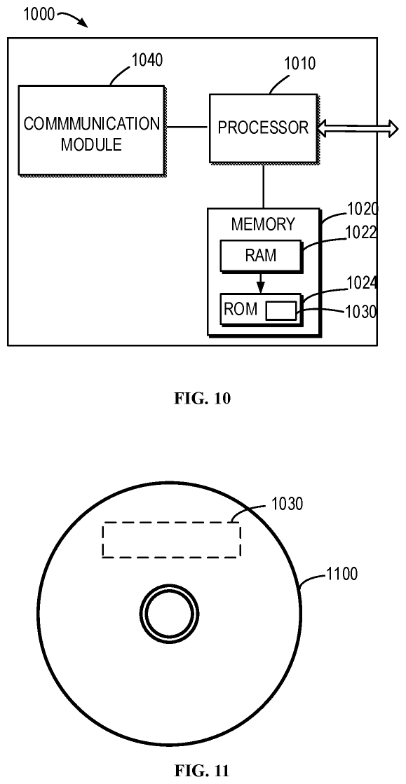

FIG. 10 is a simplified block diagram of a device 1000 that is suitable for implementing example embodiments of the present disclosure. The device 1000 may be provided to implement a communication device, for example, the first device 110 or the second device 120 as shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has one or more communication interfaces to facilitate communication with one or more other modules or devices. The communication interfaces may represent any interface that is necessary for communication with other network elements. In some example embodiments, the communication module 1040 may include at least one antenna.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the memory, e.g., ROM 1024. The processor 1010 may perform any suitable actions and processing by loading the program 1030 into the RAM 1022.

The example embodiments of the present disclosure may be implemented by means of the program 1030 so that the device 1000 may perform any process of the disclosure as discussed with reference to FIGS. 3 to 5. The example embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 which may be in form of CD, DVD or other optical storage disk. The computer readable medium has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The term “non-transitory,” as used herein, is a limitation of the medium itself (i.e., tangible, not a signal) as opposed to a limitation on data storage persistency (e.g., RAM vs. ROM). The computer program product includes computer-executable instructions, such as those included in program modules, being executed in a device on a target physical or virtual processor, to carry out any of the methods as described above with reference to FIGS. 2 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-28. (canceled)

29. A first device comprising:
at least one processor; and
at least one memory storing instructions that, when executed by the at least one processor, cause the first device at least to:
determine, using a classification model, a classification result of a communication channel based at least in part on channel measurement information about the communication channel;
determine, based at least in part on a type of the classification model, importance assessment information to indicate an importance level of the channel measurement information in updating the classification model; and
transmit the importance assessment information to a second device.

30. The first device of claim 29, wherein the at least one memory storing instructions that, when executed by the at least one processor, cause the first device to determine the importance assessment information by:
determining whether the type of the classification model is a first type or a second type;
in accordance with a determination that the type of the classification model is the first type, determining an uncertainty level of the classification result, and
generating the importance assessment information to comprise at least the uncertainty level of the classification result; and
in accordance with a determination that the type of the classification model is the second type, generating the importance assessment information to comprise at least the channel measurement information.

31. The first device of claim 29, wherein the at least one memory storing instructions that, when executed by the at least one processor, cause the first device to determine the importance assessment information by:
determining whether the type of the classification model is a first type or a second type;
in accordance with a determination that the type of the classification model is the first type, determining an uncertainty level of the classification result, and
generating the importance assessment information to comprise at least the uncertainty level of the classification result;
in accordance with a determination that the type of the classification model is the second type, generating the importance assessment information to comprise at least the channel measurement information,
wherein the classification model of the first type is a type of model with an uncertainty level of a classification result to be determined without reconstructing the classification model, and
wherein the classification model of the second type is a type of model with an uncertainty level of a classification result to be determined by reconstructing the classification model.

32. The first device of claim 29, wherein the at least one memory storing instructions that, when executed by the at least one processor, cause the first device to determine the importance assessment information by:
determining whether the type of the classification model is a first type or a second type;
in accordance with a determination that the type of the classification model is the first type, determining an uncertainty level of the classification result, and
generating the importance assessment information to comprise at least the uncertainty level of the classification result;
in accordance with a determination that the type of the classification model is the second type, generating the importance assessment information to comprise at least the channel measurement information,
wherein the classification result indicates whether the communication channel is classified into a first channel category or a second channel category, and the classification result determined using the classification model of the first type is based on a ratio of a first number of model votes for the first channel category to a second number of model votes for the second channel category; and
wherein the at least one memory storing instructions that, when executed by the at least one processor, cause the first device to determine the uncertainty level by:
determining a degree of difference between the first number and the second number, and
determining the uncertainty level based on the degree of difference.

33. The first device of claim 29, wherein the at least one memory storing instructions that, when executed by the at least one processor, cause the first device to determine the importance assessment information by:
determining whether the type of the classification model is a first type or a second type;
in accordance with a determination that the type of the classification model is the first type, determining an uncertainty level of the classification result, and
generating the importance assessment information to comprise at least the uncertainty level of the classification result;
in accordance with a determination that the type of the classification model is the second type, generating the importance assessment information to comprise at least the channel measurement information, and
wherein the at least one memory storing instructions that, when executed by the at least one processor, cause the first device to transmit the importance assessment information to the second device by:
in accordance with a determination that the determined uncertainty level exceeds an uncertainty threshold, transmitting, to the second device, the importance assessment information.

34. The first device of claim 29, wherein the at least one memory storing instructions that, when executed by the at least one processor, cause the first device to determine the importance assessment information by:
determining whether the type of the classification model is a first type or a second type;
in accordance with a determination that the type of the classification model is the first type, determining an uncertainty level of the classification result;
generating the importance assessment information to comprise at least the uncertainty level of the classification result;
in accordance with a determination that the type of the classification model is the second type, generating the importance assessment information to comprise at least the channel measurement information,
wherein the at least one memory storing instructions that, when executed by the at least one processor, cause the first device to transmit the importance assessment information to the second device by:
in accordance with a determination that the determined uncertainty level exceeds an uncertainty threshold, transmitting, to the second device, the importance assessment information, and
wherein the at least one memory storing instructions that, when executed by the at least one processor, further cause the first device to:
receive the uncertainty threshold from the second device.

35. The first device of claim 29, wherein the at least one memory storing instructions that, when executed by the at least one processor, cause the first device to determine the importance assessment information by:
determining whether the type of the classification model is a first type or a second type;
in accordance with a determination that the type of the classification model is the first type, determining an uncertainty level of the classification result;
generating the importance assessment information to comprise at least the uncertainty level of the classification result;
in accordance with a determination that the type of the classification model is the second type, generating the importance assessment information to comprise at least the channel measurement information, and
wherein the classification result is determined based on a predictive probability provided by the classification model of the second type, to indicate whether the communication channel is classified into a first channel category or a second channel category.

36. The first device of claim 29, wherein the at least one memory storing instructions that, when executed by the at least one processor, cause the first device to determine the importance assessment information by:
determining whether the type of the classification model is a first type or a second type;
in accordance with a determination that the type of the classification model is the first type, determining an uncertainty level of the classification result;
generating the importance assessment information to comprise at least the uncertainty level of the classification result;
in accordance with a determination that the type of the classification model is the second type, generating the importance assessment information to comprise at least the channel measurement information, and
wherein the at least one memory storing instructions that, when executed by the at least one processor, further cause the first device to:
receive, from the second device, an update to at least the classification model.

37. The first device of claim 29, wherein the classification result indicates whether the communication channel is classified into a line-of-sight channel or a non-line-of-sight channel.

38. The first device of claim 29, wherein the first device comprises a terminal device, and the second device comprises a location management function, and
wherein the communication channel comprises a channel between the terminal device and a network device.

39. A second device comprising:
at least one processor; and
at least one memory storing instructions that, when executed by the at least one processor, cause the second device at least to:
receive, from a first device, importance assessment information indicating an importance level of channel measurement information in updating a classification model, the classification model being used for determining a classification result of a communication channel based on the channel measurement information;
determine whether the importance level of the channel measurement information exceeds an importance threshold; and
in accordance with a determination that the importance level of the channel measurement information exceeds the importance threshold, cause a third device to perform classification labeling for at least the communication channel at a location associated with the first device.

40. The second device of claim 39, wherein the at least one memory storing instructions that, when executed by the at least one processor, further cause the second device to:
receive, from the third device, at least one pair of sample channel measurement information about the communication channel and a ground-truth classification result labeled for the sample channel measurement information; and
update at least the classification model based on the at least one pair of sample channel measurement information and the ground-truth classification result.

41. The second device of claim 39, wherein the at least one memory storing instructions that, when executed by the at least one processor, further cause the second device to:
receive, from the third device, at least one pair of sample channel measurement information about the communication channel and a ground-truth classification result labeled for the sample channel measurement information;
update at least the classification model based on the at least one pair of sample channel measurement information and the ground-truth classification result, and
wherein the at least one memory storing instructions that, when executed by the at least one processor, further cause the second device to:
transmit, to the first device, an update to at least the classification model.

42. The second device of claim 39, wherein the at least one memory storing instructions that, when executed by the at least one processor, cause the second device to receive the importance assessment information by:
in accordance with a determination that the classification model is of a first type, receiving the importance assessment information comprising at least an uncertainty level of the classification result; and
in accordance with a determination that the classification model is of a second type, receiving the importance assessment information comprising at least the channel measurement information.

43. The second device of claim 39, wherein the at least one memory storing instructions that, when executed by the at least one processor, cause the second device to receive the importance assessment information by:
in accordance with a determination that the classification model is of a first type, receiving the importance assessment information comprising at least an uncertainty level of the classification result
in accordance with a determination that the classification model is of a second type, receiving the importance assessment information comprising at least the channel measurement information,
wherein the classification model of the first type is a type of model with an uncertainty level of a classification result to be determined without reconstructing the classification model, and
wherein the classification model of the second type is a type of model with an uncertainty level of a classification result to be determined by reconstructing the classification model.

44. The second device of claim 39, wherein the at least one memory storing instructions that, when executed by the at least one processor, cause the second device to receive the importance assessment information by:
in accordance with a determination that the classification model is of a first type, receiving the importance assessment information comprising at least an uncertainty level of the classification result;
in accordance with a determination that the classification model is of a second type, receiving the importance assessment information comprising at least the channel measurement information, and
wherein the at least one memory storing instructions that, when executed by the at least one processor, further cause the second device to:
in accordance with a determination that the importance assessment information comprises at least the channel measurement information, determine an uncertainty level of the classification result based on the channel measurement information.

45. The second device of claim 39, wherein the at least one memory storing instructions that, when executed by the at least one processor, cause the second device to receive the importance assessment information by:
in accordance with a determination that the classification model is of a first type, receiving the importance assessment information comprising at least an uncertainty level of the classification result;
in accordance with a determination that the classification model is of a second type, receiving the importance assessment information comprising at least the channel measurement information;
wherein the at least one memory storing instructions that, when executed by the at least one processor, further cause the second device to:
in accordance with a determination that the importance assessment information comprises at least the channel measurement information, determine an uncertainty level of the classification result based on the channel measurement information,
wherein the classification model is of a second type, and wherein the at least one memory storing instructions that, when executed by the at least one processor, cause the second device to determine the uncertainty level of the classification result by:
generating a plurality of reference classification models by reconstructing the classification model;
determining, using the plurality of reference classification models, a plurality of reference classification results based on the channel measurement information, and
determining the uncertainty level of the classification result based on a variance of the plurality of reference classification results.

46. The second device of claim 39, wherein the at least one memory storing instructions that, when executed by the at least one processor, cause the second device to receive the importance assessment information by:
in accordance with a determination that the classification model is of a first type, receiving the importance assessment information comprising at least an uncertainty level of the classification result;
in accordance with a determination that the classification model is of a second type, receiving the importance assessment information comprising at least the channel measurement information;
wherein the at least one memory storing instructions that, when executed by the at least one processor, further cause the second device to:
in accordance with a determination that the importance assessment information comprises at least the channel measurement information, determine an uncertainty level of the classification result based on the channel measurement information,
wherein the classification model is of a second type, and wherein the at least one memory storing instructions that, when executed by the at least one processor, cause the second device to determine the uncertainty level of the classification result by:
generating a plurality of reference classification models by reconstructing the classification model;
determining, using the plurality of reference classification models, a plurality of reference classification results based on the channel measurement information;
determining the uncertainty level of the classification result based on a variance of the plurality of reference classification results, and
wherein the at least one memory storing instructions that, when executed by the at least one processor, cause the second device to generate the plurality of reference classification models by applying random neural connection dropout on the classification model.

47. The second device of claim 39, wherein the at least one memory storing instructions that, when executed by the at least one processor, cause the second device to receive the importance assessment information by:
in accordance with a determination that the classification model is of a first type, receiving the importance assessment information comprising at least an uncertainty level of the classification result
in accordance with a determination that the classification model is of a second type, receiving the importance assessment information comprising at least the channel measurement information,
wherein the classification model of the first type is a type of model with an uncertainty level of a classification result to be determined without reconstructing the classification model;
wherein the classification model of the second type is a type of model with an uncertainty level of a classification result to be determined by reconstructing the classification model, and
wherein the at least one memory storing instructions that, when executed by the at least one processor, cause the second device to receive, from the first device, the uncertainty level of the classification result exceeding an uncertainty threshold.

48. The second device of claim 39, wherein the at least one memory storing instructions that, when executed by the at least one processor, further cause the second device to:
transmit the uncertainty threshold to the first device.

49. The second device of claim 39, wherein the uncertainty threshold is determined based on an accuracy level of the classification model, and
wherein the uncertainty threshold is updated based on an update to the classification model.

50. The second device of claim 39, wherein the classification result indicates whether the communication channel is classified into a line-of-sight channel or a non-line-of-sight channel.

51. The second device of claim 39, wherein the first device comprises a terminal device, the second device comprises a location management function, and the third device comprises a positioning reference unit, and
wherein the communication channel comprises a channel between the terminal device and a network device.
